(19) United States
(12) Patent Application Publication
(10) Pub. No.: US 2017/0261662 A1
(43) Pub. Date: Sep. 14, 2017

(54) OPTICAL DEVICE MANUFACTURING METHOD

(71) Applicant: Electronics and Telecommunications Research Institute, Daejeon (KR)

(72) Inventors: Seung Youl LEE, Daejeon (KR); Yong Hae KIM, Daejeon (KR); Tae-Youb KIM, Daejeon (KR); Seong-Mok CHO, Daejeon (KR); Han Byeol KANG, Suwon (KR); Hanna KIM, Daejeon (KR); Chi-Sun HWANG, Daejeon (KR)

(21) Appl. No.: 15/413,293

(22) Filed: Jan. 23, 2017

(30) Foreign Application Priority Data
Mar. 14, 2016 (KR) 10-2016-0030462
Aug. 12, 2016 (KR) 10-2016-0103227

(51) Int. Cl. G02B 5/18; G02B 27/00

(52) U.S. Cl. CPC G02B 5/1828; G02B 27/0012; G02B 5/1861; G02B 5/1847

(57) ABSTRACT

Provided is an optical device manufacturing method including forming a reflection layer on a substrate, forming a dielectric layer on the reflection layer, and inserting a phase change material layer into the dielectric layer, wherein the inserting of the phase change material layer includes adjusting a position of the phase change material layer to be inserted into the dielectric layer according to a wavelength of incident light incident to the dielectric layer.

### CROSS-REFERENCE TO RELATED APPLICATIONS

This U.S. non-provisional patent application claims priority under 35 U.S.C. §119 of Korean Patent Application Nos. 10-2016-0030462, filed on Mar. 14, 2016, and 10-2016-0103227, filed on Aug. 12, 2016, the entire contents of which are hereby incorporated by reference.

### BACKGROUND

The present disclosure herein relates to an optical device manufacturing method, and more particularly, to a method of manufacturing a diffractive optical device including a phase change material between dielectric layers.

A compound of germanium, antimony, and tellurium (Ge₂Sb₂Te₅, GST) is a phase change material and active researches thereon are currently in progress in fields of optical information recording medium such as DVD and memory. The GST compound changes to an amorphous and/or crystalline state according to a temperature and has different electrical resistivities and optical characteristics according to each state. In a structure in which a phase of the GST compound varies, diffraction may occur due to a reflection coefficient phase difference between a peripheral crystalline part and a peripheral amorphous part and a diffraction grating may be designed using the same.

### SUMMARY

The present disclosure provides a method of manufacturing a wavelength selective optical device.

Issues to be addressed in the present disclosure are not limited to those described above and other issues unmentioned above will be clearly understood by those skilled in the art from the following description.

An embodiment of the inventive concept provides an optical device manufacturing method including: forming a reflection layer on a substrate; forming a dielectric layer on the reflection layer; and inserting a phase change material layer into the dielectric layer, wherein the inserting of the phase change material layer includes adjusting a position of the phase change material layer to be inserted into the dielectric layer according to a wavelength of incident light incident to the dielectric layer.

In an embodiment, the forming of the dielectric layer may include adjusting a thickness of the dielectric layer according to the wavelength of the incident light.

In an embodiment, the thickness t_{d,q} of the dielectric layer satisfies the following equation,

$${t}_{d , q} = \frac{( 2 q - 1 ) {λ}_{0}}{4 {n}_{d}} , ( q = 1 , 2 , 3 … )$$

where q denotes a resonance order, n_{d} denotes a refractive index of the dielectric layer, and λ₀ denotes the wavelength of the incident light.

In an embodiment, the dielectric layer may include: an upper dielectric layer on the phase change material layer; and a lower dielectric layer under the phase change material layer, wherein a ratio P_{q,r} of a thickness of the upper dielectric layer to the thickness of the dielectric layer satisfies the following equation,

$${P}_{q , r} = \frac{( 2 r - 1 )}{2 q} , ( r = 1 , 2 , … , q )$$

where q denotes the resonance order and r denotes an arbitrary natural number.

In an embodiment, the phase change material layer may include a chalcogenide material.

In an embodiments of the inventive concept, an optical device manufacturing method includes: forming a reflection layer on a substrate; forming a first dielectric layer having a first thickness on the reflection layer; forming a phase change material layer on the first dielectric layer; and forming a second dielectric layer having a second thickness on the phase change material layer, wherein a sum of the first and second thicknesses has a prescribed thickness and the prescribed thickness is proportional to a wavelength of incident light incident to the substrate.

In an embodiment, the prescribed thickness t_{d,q} may satisfy the following equation,

$${t}_{d , q} = \frac{( 2 q - 1 ) {λ}_{0}}{4 {n}_{d}} , ( q = 1 , 2 , 3 … )$$

where q denotes a resonance order, n_{d} denotes a refractive index of the dielectric layer, and λ₀ denotes the wavelength of the incident light.

In an embodiment, at least one of the first and second thicknesses may be adjusted according to the wavelength of the incident light.

In an embodiment, a ratio P_{q,r} of the second thickness to the prescribed thickness may satisfy the following equation,

$${P}_{q , r} = \frac{( 2 r - 1 )}{2 q} , ( r = 1 , 2 , … , q )$$

where q denotes the resonance order and r denotes an arbitrary natural number.

In an embodiment, the first and second dielectric layers may include an identical material.

In an embodiment, the phase change material layer may include a chalcogenide material.

Specific items of other embodiments are included in the detailed description and drawings of the present invention.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a cross-sectional view of an optical device according to an embodiment of the inventive concept;

FIG. 2A illustrates that incident light is incident to an optical device and FIG. 2B illustrates that diffractive light is output from the optical device;

FIG. 3 is a flowchart illustrating a method of manufacturing the optical device of FIG. 1;

FIG. 4 is a view illustrating a phase difference between reflection coefficients according to thicknesses of upper and lower dielectric layers;

FIG. 5A illustrates a diffraction efficiency for red light;

FIG. 5B illustrates a diffraction efficiency for green light;

FIG. 5C illustrates a diffraction efficiency for blue light; and

FIG. 6 illustrates diffraction efficiencies according to a wavelength of incident light for cases of condition \hat{1} to condition \hat{2} shown in FIGS. 5A to 5C.

### DETAILED DESCRIPTION

Advantages and features of the present invention, and methods for achieving the same will be cleared with reference to exemplary embodiments described later in detail together with the accompanying drawings. However, the present invention is not limited to the following exemplary embodiments, but realized in various forms. In other words, the present exemplary embodiments are provided just to complete disclosure the present invention and make a person having an ordinary skill in the art understand the scope of the invention. The present invention should be defined by only the scope of the accompanying claims. Throughout this specification, like numerals refer to like elements.

The terms and words used in the following description and claims are to describe embodiments but are not limited the inventive concept. As used herein, the singular forms “a,” “an” and “the” are intended to include the plural forms as well, unless the context clearly indicates otherwise. It will be further understood that the terms “comprises” and/or “comprising” used herein specify the presence of stated components, operations and/or elements but do not preclude the presence or addition of one or more other components, operations and/or elements.

Example embodiments are described herein with reference to cross-sectional views and/or plan views that are schematic illustrations of example embodiments. In the drawings, the thicknesses of layers and regions are exaggerated for clarity. As such, variations from the shapes of the illustrations as a result, for example, of manufacturing techniques and/or tolerances, are to be expected. Thus, example embodiments should not be construed as limited to the particular shapes of regions illustrated herein but may be to include deviations in shapes that result, for example, from manufacturing. Thus, the regions illustrated in the figures are schematic in nature and their shapes may be not intended to illustrate the actual shape of a region of a device and are not intended to limit the scope of example embodiments.

Hereinafter, exemplary embodiments of the inventive concept will be described in detail with reference to the accompanying drawings.

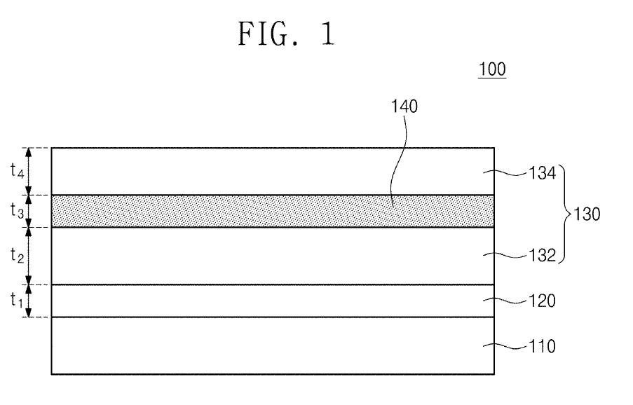

FIG. 1 is a cross-sectional view of an optical device 100 according to an embodiment of the inventive concept. The optical device 100 may be a diffractive optical device. Referring to FIG. 1, the optical device 100 may include a substrate 110, a reflective layer 120, a dielectric layer 130, and a phase change material layer 140. The optical device 100 may be a wavelength-selective diffraction optical device. In other words, the optical device 100 may be a diffractive optical device for specific incident light.

A substrate 110 may be, but is not limited to, a wafer and may have various types. A reflective layer 120 is disposed on the substrate 110. The reflective layer 120 may include a metal, for example, Al, Ag, or TiW, etc. The reflective layer 120 may include a material having a high reflection ratio in a wavelength band of incident light intended to be designed. The reflective layer 120 may have a first thickness t₁. For example the first thickness t1 may be approximately 100 nm or greater. The reflective layer 120 may be thicker than the penetration depth of the incident light and the incident light may be not delivered to the substrate 110 lower than the reflective layer 120.

The dielectric layer 130 may include a first dielectric layer 132 and a second dielectric layer 134. The first dielectric layer 132 may be disposed under the phase change material layer 140, and the second dielectric layer 134 may be disposed on the phase change material layer 140. Hereinafter, the first dielectric layer 132 will be referred to a lower dielectric layer 132 and the second dielectric layer 134 will be referred to an upper dielectric layer 134. The lower dielectric layer 132 may have a second thickness t2 and the upper dielectric layer 134 may have a fourth thickness t4. Each of the lower and upper dielectric layers 132 and 134 may include a transparent material of which a refractive index is known. The lower and upper dielectric layers 132 and 134 may include an identical material. For example, the lower and upper dielectric layers 132 and 134 may include SiO₂ or ITO.

The phase change material layer 140 may be interposed between the lower and upper dielectric layers 132 and 134. The phase change material layer 140 may include a phase change material. The phase of the phase change material may be changed by an electric, thermal, or optical signal. The phase change material layer 140 may include a chalcogenide material. For example, the phase change material 140 may include a compound of germanium-antimony-tellurium (Ge₂Sb₂Te₅, GST). The GST compound may be changed to an amorphous/crystalline state according to a temperature. According to the amorphous/crystalline state, electrical resistivity and optical characteristic of the GST compound may be differed. The phase change material layer 140 may have a third thickness t₃. When the third thickness t₃ is provided to be small, the lower and upper dielectric layers 132 and 134 may form one resonance structure. The third thickness t₃ may be from approximately 5 nm to approximately 20 nm. For example, the third thickness t₃ may be approximately 7 nm.

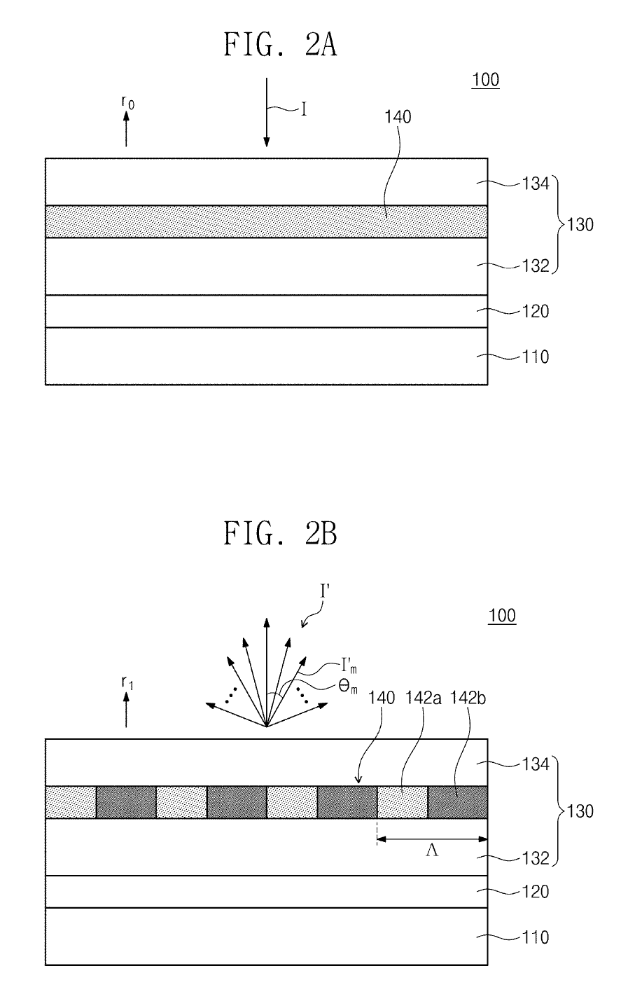

FIGS. 2A and 2B are views showing that the optical device 100 of FIG. 1 functions as a diffractive optical device. FIG. 2A illustrates that incident light I is incident to the optical device 100 and FIG. 2B illustrates that diffractive lights I′ are output from the optical device 100. As described above, the phase change material layer 140 may include a GST compound. Referring to FIG. 2A, the incident light I is incident to the optical device 100. The incident light I is incident perpendicularly to the optical device 100. The GST compound before a phase change has an amorphous state and the optical device 100 including the amorphous GST compound has a first reflection coefficient r₀.

Referring to FIG. 2B, at least a part of the phase change material layer 140 is changed to have a crystalline state due to an external optical stimulus. For example, the optical stimulus may be caused by the incident light I. Unlike this, the crystalline state of the phase change material layer 140 may be changed by an external thermal or electrical stimulus. Due to the phase change, the phase change material layer 140 may include a first part 142a having an amorphous state and a second part 142b having a crystalline state. The reflection coefficients of the first part 142a and the second part 142b become differed from each other, and thus the optical device 100 including the phase change material layer 140 after the phase change occurs has a second reflection coefficient r₁. Due to the reflection coefficient difference between the first part 142a and the second part 142b, the diffractive lights I′ may be generated. The diffractive lights I′ may include 0th order diffractive light, ±1st order diffractive lights, ±2nd order diffractive lights, . . . , and ±nth order diffractive lights. The 0th order diffractive light travels in the opposite direction to an incident direction, namely, in a direction perpendicular to the optical device 100. The ±1st order diffractive lights, ±2nd order diffractive lights, . . . , and ±nth order diffractive lights are diffractive lights sequentially moving from the 0th diffractive light, and diffractive lights having the same order may be symmetric to each other around the 0th order diffraction light. The diffractive lights I′ may respectively have specific diffraction angles with respect to a plane perpendicular to the optical device 100. In detail, a m-th diffraction angle θₘ of m-th diffractive light I'm satisfies the following Equation (1) where, 1≦|m|≦n. The m-th diffractive angle θₘ is an angle made by the m-th diffractive light I'm from a plane perpendicular to the optical device 100.

θₘ=sin⁻¹(mλ₀/Λ) (1)

where Λ denotes a grating period of the phase change material layer 140, λ₀ denotes a wavelength of the incident light I, and m denotes a diffraction order and has an arbitrary integer value. The grating period Λ may be the same as a sum of the width of the first part 142a and the width of the second part 142b.

The diffraction efficiency of the ±1st order diffractive lights, which are mainly used for a diffractive optical device and holography among the diffractive lights I′, satisfies the following Equation (2). The ±1st order diffractive lights are lights most adjacent to the 0th-order diffractive light.

$${D}_{I} = \frac{\vert {r}_{1} - {r}_{0} {\vert}^{2}}{{π}^{2}} \qquad ( 2 )$$

where, as described above, r₀ denotes a first reflection coefficient of the optical device 100 before the phase change occurs and r₁ denotes a second reflection coefficient of the optical device 100 after the phase change occurs.

As checked in the above Equation, |r₁−r₀| is required to be increased to increase the diffraction efficiency of the ±1st order diffractive lights. As mathematically checked from Equation (2), r₀ and r₁ are complex numbers and as a phase difference between r₀ and r₁ is closer to 180°, the larger the diffraction efficiency is. Accordingly, the optical device 100 having a high diffraction efficiency may be obtained by increasing the phase difference between r₀ and r₁.

As described above, since the phase change material layer 140 is provided with a relatively thin thickness, the lower and upper dielectric layers 132 and 134 may form a single resonance structure. When a sum t_{d}=t₂+t₄ of thicknesses of the lower and upper dielectric layers 132 and 134 satisfies the following Equation (3), a Fabry-Perot resonance condition may be satisfied. Hereinafter, the sum t_{d} of the thicknesses of the lower and upper dielectric layers 132 and 134 will be referred to a total dielectric thickness t_{d}. When the total dielectric thickness t_{d} satisfies the Fabry-Perot resonance condition, the phase difference |r₁−r₀| of the reflection coefficients r₀ and r₁ may be increased.

$${t}_{d , q} = \frac{( 2 q - 1 ) {λ}_{0}}{4 {n}_{d}} , ( q = 1 , 2 , 3 … ) \qquad ( 3 )$$

where q denotes a resonance order, n_{d} is a refractive index of the dielectric layer 130, and λ₀ denotes the wavelength of the incident light I.

At this time, n_{d} may be a composite refractive index of the first and second dielectric layers 132 and 134. For example, the composite refractive index may be a single refractive index converted from refractive indexes of a plurality of layers.

Due to the Fabry-Perot resonance effect, strong electric field parts and weak electric field parts are formed inside the lower and upper dielectric layers 132 and 134. At this time, the resonance effect may be increased by inserting the phase change material layer 140 at a position where the electric field is strongest. When the phase change material layer 140 is inserted at the position where the electric field is strong, amount of the incident light I absorbed into the phase change material layer 140 may have highest value. Thus, differences of absorbance/reflectance of the phase change material layer 140 may have highest values, respectively. In other words, as mentioned above, it is substantially same with increasing the phase difference of the reflection coefficients. A position where the electric field is the greatest under the resonance condition exists as many as the resonance order q. The position where the electric field is the greatest inside the dielectric layer 130 may be expressed as a ratio P=t₄/t_{d} of the thickness t₄ of the upper dielectric layer 134 to the total dielectric thickness t_{d} and is defined as the following Equation (4).

$${P}_{q , r} = \frac{( 2 r - 1 )}{2 q} , ( r = 1 , 2 , … , q ) \qquad ( 4 )$$

where q denotes the resonance order and r denotes an arbitrary natural number. For example, the position is given such that when q=1, P_{1,1}=½; when q=2, P_{2,1}=¼ and P₂₂=¾; when q=3, P_{3,1}=⅙, P_{3,2}= 3/6, and P_{3,3}=⅚.

Namely, the total dielectric thickness t_{d} may be set to satisfy Equation (3) and the thicknesses t₂ and t₄ of the lower and upper dielectric layers 132 and 134 may be respectively set according to Equation (4). In other words, the total dielectric thickness t_{d} may be set to satisfy Equation (3) and the insertion position of the phase change material layer 140 may be set between the lower and upper dielectric layers 132 and 134 according to Equation (4). At this time, since Equation (3) is a function of the wavelength λ₀ of the incident light I, selective design is possible according to the incident light I of the optical device 100 to be designed. In addition, since the first thickness t₁ of the reflection layer 120 is formed to be sufficiently large, the reflection layer 120 and the substrate 110 do not affect the reflection coefficient of the optical device 100.

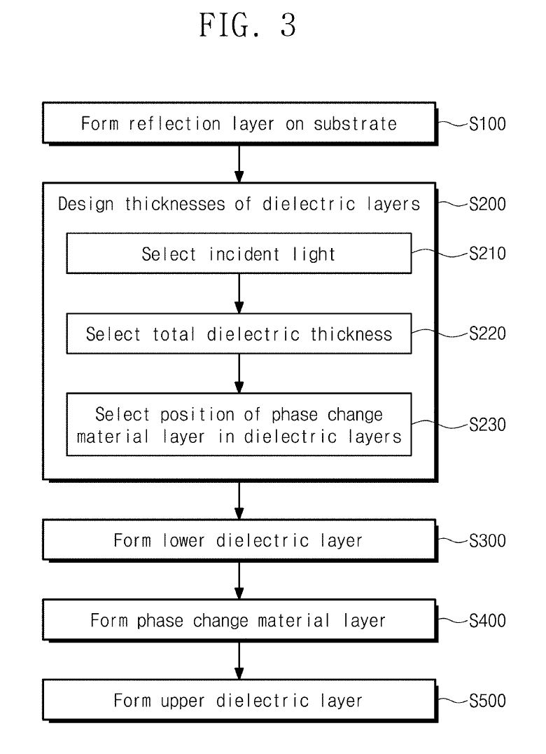

FIG. 3 is a flowchart illustrating a method of manufacturing the optical device 100 of FIG. 1. Referring to FIGS. 1 and 3, the reflection layer 120 is deposited on the substrate 110 (step S100). The substrate 110 may be, but is not limited to, a silicon wafer. The reflective layer 120 is deposited uniformly on the substrate 110. For example, the reflection layer 120 may be deposited by ion implantation or chemical vapor deposition, but is not limited thereto. The reflective layer 120 may include a metal having a high reflection ratio in a visible light band, for example, Al, Ag, or TiW, etc. Then, the thicknesses of the dielectric layers 130 are designed (step S200). Firstly, the wavelength λ₀ of the incident light is selected (step S210). According to the incident light I, the total dielectric thickness t_{d} may be selected (step S220). In detail, the total dielectric thickness t_{d} is selected to satisfy Equation (3).

$${t}_{d , q} = \frac{( 2 q - 1 ) {λ}_{0}}{4 {n}_{d}} , ( q = 1 , 2 , 3 … ) \qquad ( 3 )$$

where q denotes a resonance order, n_{d} is a refractive index of the dielectric layer 130, and λ₀ denotes the wavelength of the incident light I.

The refractive index of the dielectric layer 130 is known and the resonance order may be selected. Then, an insertion position of the phase change material layer 140 may be selected in the dielectric layers 120 (step S230). In other words, the thicknesses t₂ and t₄ of the lower and upper dielectric layers 132 and 134 may be respectively selected. The thicknesses t₂ and t₄ of the lower and upper dielectric layers 132 and 134 may be expressed as the ratio P=t₄/t_{d} of the thickness t₄ of the upper dielectric layer 134 to the total dielectric thickness t_{d} and is defined as the following Equation (4).

$${P}_{q , r} = \frac{( 2 r - 1 )}{2 q} , ( r = 1 , 2 , … , q ) \qquad ( 4 )$$

where q denotes the resonance order and r denotes an arbitrary natural number.

After the thicknesses t₂ and t₄ of the lower and upper dielectric layers 132 and 134 are respectively selected, the lower dielectric layer 132, the phase change material layer 140, and the upper dielectric layer 134 may be sequentially formed (steps S300, S400, and S500). The lower and upper dielectric layers 132 and 134, and the phase change material layer 140 may be formed through deposition processes. For example, they may be deposited by ion implantation or chemical vapor deposition, but the deposition method is not limited thereto. The lower and upper dielectric layers 132 and 134 may include an identical material. The lower dielectric layer 132 may be formed to have the second thickness t₂ and the upper dielectric layer 134 may be formed to have the fourth thickness t₄. The lower and upper dielectric layers 132 and 134 may include a transparent material of which the refractive index is known. For example, the lower and upper dielectric layers 132 and 134 may include SiO₂ or ITO. The phase change material layer 140 may include a chalcogenide material. For example, the phase change material 140 may include a GST compound. Through such processes, the optical device 100 of FIG. 1 may be manufactured.

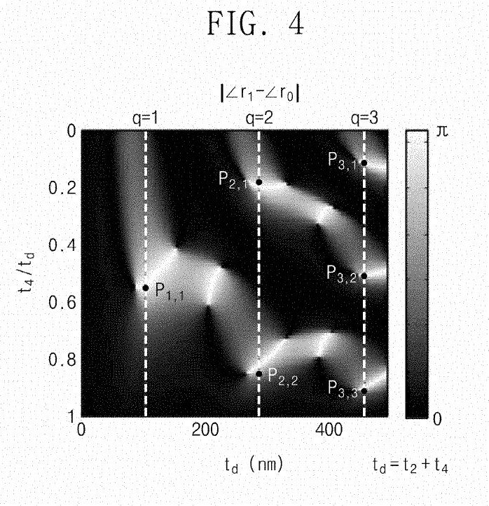

FIG. 4 is a view illustrating a phase difference between reflection coefficients according to the thicknesses t₂ and t₄ of the upper and lower dielectric layers 132 and 134. In FIG. 4, green light is exemplified and the wavelength of the incident light I is approximately 532 nm. In addition, silicon is used as the substrate 110, Al is used as the reflection layer 120, and SiO₂ is used as the dielectric layer 130. Referring to FIG. 4, it may be checked that points at which the phase differences between reflection coefficients in resonance order are the greatest are formed as many as each resonance order, and the phase difference between reflection coefficients is the greatest at a position at which the total dielectric thickness t_{d} and the ratio P=t₄/t_{d} of the thickness t₄ of the upper dielectric layer 134 to the total dielectric thickness t_{d} are concurrently satisfied. For example, it may be checked that the positions are similar to those obtained from Equation (4) in which P_{1,1}=½, when q=1; P_{2,1}=¼, P_{2,2}=¾, when q=2; and P_{3,1}=⅙, P_{3,2}= 3/6, P_{3,3}=⅚, when q=3.

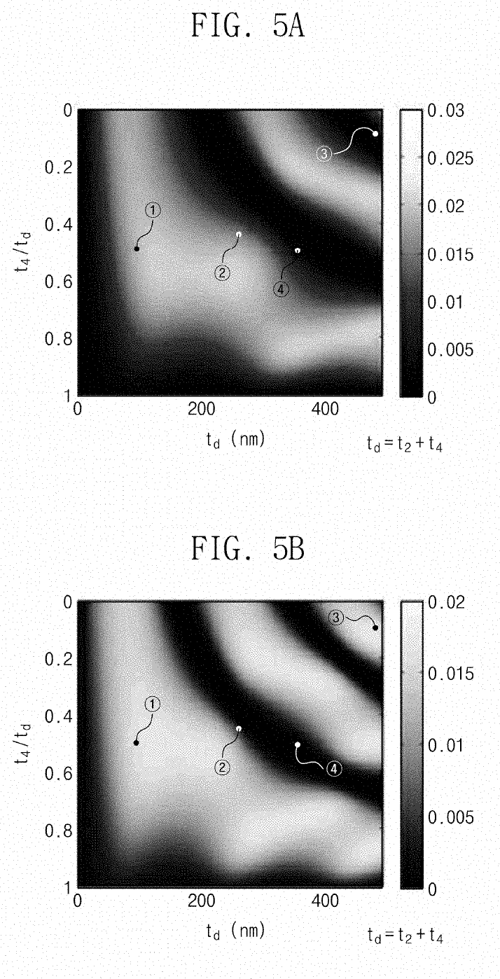

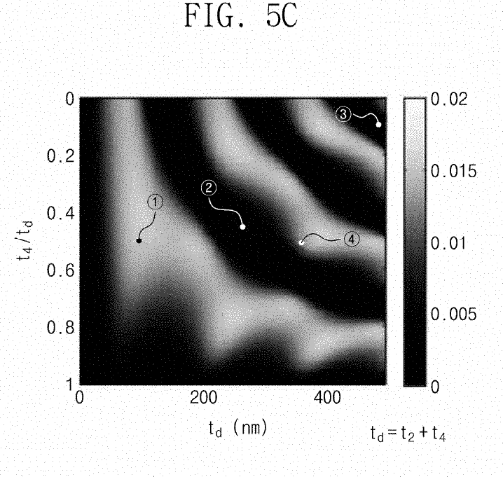

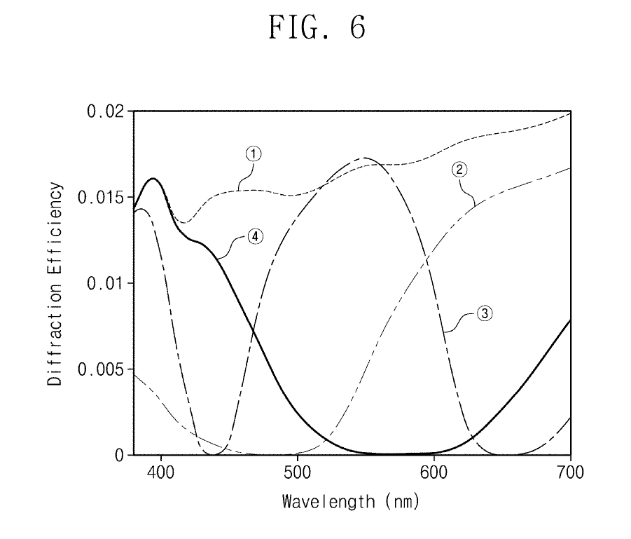

FIGS. 5A to 5C are views respectively showing diffraction efficiencies according to the ratio P=t₄/t_{d} of the thickness t₄ of the upper dielectric layer 134 to the total dielectric thickness t_{d} in a wavelength band of specific input light. FIG. 5A shows the diffraction efficiency for red light, FIG. 5B shows the diffraction efficiency for green light, and FIG. 5C shows the diffraction efficiency for blue light. In particular, referring to FIGS. 4 and 5B in which green light is exemplified, it may be known that a phase difference distribution and a diffraction efficiency distribution are similar to each other. Condition \hat{1}, condition \hat{2}, condition \hat{3}, and condition \hat{4} are respective points at which diffraction efficiencies of white light, red light, green light, and blue light are maximum. The respective diffraction efficiencies at condition \hat{1}, condition \hat{2}, condition \hat{3}, and condition \hat{4} in FIGS. 5A to 5C may be compared with each other to be extracted. FIG. 6 illustrates diffraction efficiencies according to the wavelength of incident light I in cases of condition \hat{1} to condition \hat{4} shown in FIGS. 5A to 5C.

In other words, referring to FIGS. 5A to 6, it may be confirmed that an optical device having the ratio P=t₄/t_{d} of the thickness t₄ of the upper dielectric layer 134 to the total dielectric thickness t_{d} of condition \hat{1} has an excellent diffraction efficiency for white light, an optical device having the ratio P=t₄/t_{d} of condition \hat{2} has an excellent diffraction efficiency for red light, an optical device having the ratio P=t₄/t_{d} of condition \hat{3} has an excellent diffraction efficiency for green light, and an optical device having the ratio P=t₄/t_{d} of condition \hat{4} has an excellent diffraction efficiency for blue light. Accordingly, without a separate color filter, a wavelength-selective diffraction optical device may be manufactured by adjusting the ratio P=t₄/t_{d} of the thickness t₄ of the upper dielectric layer 134 to the total dielectric thickness t_{d} according to the wavelength of the incident light I. For example, condition \hat{1}, condition \hat{2}, condition \hat{3}, and condition \hat{4} may respectively have values shown in the following table. However, condition \hat{1}, condition \hat{2}, condition \hat{3}, and condition \hat{4} are only examples through which diffractive optical devices for specific incident lights may be designed and other design schemes with various combinations are allowable.

TABLE

| | Reflective | Lower | | Phase change | Upper | |
|---|---|---|---|---|---|---|
| | metal | dielectric | | material | dielectric | |
| | layer(t₁) | layer(t₂) | | layer(t₃) | layer(t₄) | |
| Condition \textcircled{1} | 300 nm | 48 | nm | 7 nm | 48 | nm |
| Condition \textcircled{2} | 300 nm | 150 | nm | 7 nm | 120 | nm |
| Condition \textcircled{3} | 300 nm | 430 | nm | 7 nm | 48 | nm |
| Condition \textcircled{4} | 300 nm | 180 | nm | 7 nm | 180 | nm |

According to the present inventive concepts, a diffractive optical device may be manufactured using a phase change material of which the property is changed according to a temperature difference and a diffraction efficiency may be increased through dielectric layers disposed on and under the phase change material layer. In addition, a wavelength-selective optical device may be manufactured by adjusting the thicknesses of the dielectric layers according to the wavelength of the incident light.

According to embodiments of the present disclosure, a diffractive optical device may be manufactured using a phase change material of which the property varies according to a temperature difference, and a wavelength selective optical device may be manufactured by adjusting thicknesses of dielectric layers according to the wavelength of incident light. In addition, a reflection coefficient phase difference according to a phase change of a phase change material is insignificant but a diffraction efficiency may be increased through dielectric layers disposed on and under a phase change material layer.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. An optical device manufacturing method comprising:
forming a reflection layer on a substrate;
forming a dielectric layer on the reflection layer; and
inserting a phase change material layer into the dielectric layer,
wherein the inserting of the phase change material layer comprises adjusting a position of the phase change material layer to be inserted into the dielectric layer according to a wavelength of incident light incident to the dielectric layer.

2. The optical device manufacturing method of claim 1, wherein the forming of the dielectric layer comprises adjusting a thickness of the dielectric layer according to the wavelength of the incident light.

3. The optical device manufacturing method of claim 2, wherein the thickness t_{d,q} of the dielectric layer satisfies the following equation,
$${t}_{d , q} = \frac{( 2 q - 1 ) {λ}_{0}}{4 {n}_{d}} , ( q = 1 , 2 , 3 … )$$
where q denotes a resonance order, n_{d} denotes a refractive index of the dielectric layer, and λ₀ denotes the wavelength of the incident light.

4. The optical device manufacturing method of claim 3, wherein the dielectric layer comprises:
an upper dielectric layer on the phase change material layer; and
a lower dielectric layer under the phase change material layer,
wherein a ratio P_{q,r} of a thickness of the upper dielectric layer to the thickness of the dielectric layer satisfies the following equation,
$${P}_{q , r} = \frac{( 2 r - 1 )}{2 q} , ( r = 1 , 2 , … , q )$$
where q denotes the resonance order and r denotes an arbitrary natural number.

5. The optical device manufacturing method of claim 1, wherein the phase change material layer comprises a chalcogenide material.

6. An optical device manufacturing method comprising:
forming a reflection layer on a substrate;
forming a first dielectric layer having a first thickness on the reflection layer;
forming a phase change material layer on the first dielectric layer; and
forming a second dielectric layer having a second thickness on the phase change material layer,
wherein a sum of the first and second thicknesses has a prescribed thickness and the prescribed thickness is proportional to a wavelength of incident light incident to the substrate.

7. The optical device manufacturing method of claim 6, wherein the prescribed thickness t_{d,q} satisfies the following equation,
$${t}_{d , q} = \frac{( 2 q - 1 ) {λ}_{0}}{4 {n}_{d}} , ( q = 1 , 2 , 3 … )$$
where q denotes a resonance order, n_{d} denotes a composite refractive index of the dielectric layers, and λ₀ denotes the wavelength of the incident light.

8. The optical device manufacturing method of claim 6, wherein at least one of the first and second thicknesses is adjusted according to the wavelength of the incident light.

9. The optical device manufacturing method of claim 8, wherein a ratio P_{q,r} of the second thickness to the prescribed thickness satisfies the following equation,
$${P}_{q , r} = \frac{( 2 r - 1 )}{2 q} , ( r = 1 , 2 , … , q )$$
where q denotes the resonance order and r denotes an arbitrary natural number.

10. The optical device manufacturing method of claim 6, wherein the first and second dielectric layers comprise an identical material.

11. The optical device manufacturing method of claim 6, wherein the phase change material layer comprises a chalcogenide material.
